(19) United States
(12) Patent Application Publication
(10) Pub. No.: US 2002/0114520 A1
(43) Pub. Date: Aug. 22, 2002

(54) Position detection device and method

(75) Inventor: Kenji Sugawara, Kokubunji-shi (JP)

Correspondence Address: KODA & ANDROLIA, 2029 Century Park East, Suite 3850, Los Angeles, CA, 90067-3024, US

(73) Assignee: KABUSHIKI KAISHA SHINKAWA

(21) Appl. No.: 10/026,253

(22) Filed: Dec. 21, 2001

(30) Foreign Application Priority Data
Dec. 22, 2000 (JP) 2000-390131

(51) Int. Cl. G06K 9/62

(52) U.S. Cl. 382/209

(57) ABSTRACT

So as to prevent erroneous recognition in position detection by pattern matching in, for instance, wire bonding, identical template images are set to be superimposed while the relative positions of such images are varied, and correlation values are calculated at respective positions so as to be taken as amounts of coincidence. The amount of coincidence between the template images shows a maximum value at a position of coincidence but drops abruptly in the vicinity of this position of coincidence. Utilizing this fact, the amount of coincidence is calculated from the correlation value between the template images and an inputted image; when the drop in the amount of coincidence, that appears near the position of maximum coincidence value, is larger than a predetermined coincidence discriminating value, a position of coincidence at the maximum coincidence value is judged as a position of coincidence of the template and the inputted image.

### BACKGROUND OF THE INVENTION

1. Field of the Invention

The present invention relates to a position detection device and method and more particularly to a position detection device and method that uses pattern matching between a reference template and an input image.

2. Prior Art

In conventional position detection by pattern matching, with the use of a template image that serves as a reference for alignment, a calculation of a correlation value as the amount of coincidence between this template image and an input image that is the object of alignment is performed for numerous trial points over the entire area of the input image. Then, the trial point showing the highest correlation value is judged to be the position of coincidence between the template image and the inputted image.

However, the trial point showing the highest correlation value is not necessarily the position of coincidence between the template image and the correlation image. Accordingly, erroneous recognition would occur especially when the image includes noise and/or distortion.

### SUMMARY OF THE INVENTION

Accordingly, the object of the present invention is to provide a means that prevents erroneous recognition in pattern matching.

The above object is accomplished by a unique structure for a position detection device that includes:

a means which acquires amounts of coincidence of identical reference templates for a position of coincidence of the templates and for a nearby position thereof, the identical reference templates being superimposed;

a means which calculates a coincidence discriminating value based upon a coincidence amount of the position of coincidence and a coincidence amount of the nearby position;

a means which acquires amounts of coincidence between one of the reference templates and an inputted image for a maximum value position at which an amount of the coincidence between such one of the reference templates and the inputted image shows a maximum value and for a nearby position of the maximum value position; and

a means which judges that the maximum value position is a coincidence position between such one of the reference templates and the inputted image, in a case where a degree of drop in an amount of coincidence at the nearby position of the maximum value position with respect to a maximum value of amount of coincidence between such one of the reference templates and the inputted image is greater than the coincidence discriminating value.

In the above structure, when identical patterns are superimposed for a plurality of combinations in which the relative positions of the two patterns are varied along specified coordinate axes, and the amounts of coincidence are respectively calculated for the respective relative positions, the amount of coincidence will show a maximum value at the position of coincidence of the two patterns. However, this amount of coincidence will drop abruptly in the vicinity of this position (see FIG. 2). The present invention utilizes this characteristic in reverse.

More specifically, the amount of coincidence of two identical reference templates is calculated for the position of coincidence of the two templates and for a position that is near this position of coincidence, and a coincidence discriminating value is calculated based upon the amount of coincidence at this position of coincidence and the amount of coincidence at this nearby position. Then, by determining the coincidence discriminating value, a judgment is made as to whether or not the amount of coincidence between the reference templates and the inputted images drops in the vicinity of the point at which a maximum value is shown. If this amount of coincidence drops abruptly, then it is judged that the reference templates and the inputted image are matched (i.e., that the point where a maximum value is shown is the position of coincidence). On the other hand, if there is no such abrupt drop, then it is judged that the reference templates and input image are not matched (i.e., that the point where a maximum value is shown is not the position of coincidence).

In other words, in the present invention, the amount of coincidence for identical reference templates is calculated at the position of coincidence of the two templates and at a nearby position, and a coincidence discriminating value is calculated based upon the amount of coincidence at the position of coincidence and the amount of coincidence at this nearby position. On the other hand, the amount of coincidence between this reference templates and an inputted image is calculated at the position where the amount of coincidence between the reference templates and the inputted image shows a maximum value, and a position that is near this position where a maximum value is shown. Then, in cases where the degree of the drop in the amount of coincidence between the reference templates and inputted image at the nearby position exceeds the coincidence discriminating value, the position where a maximum value is shown is judged to be the position of coincidence between the reference templates and inputted image.

Accordingly, in the present invention, it can be judged with a high degree of precision whether or not the reference templates and inputted image in a certain relative position are in the position of coincidence, without generating erroneous detection by viewing the point where the correlation values shows a maximum value to be the position of coincidence as in conventional methods.

The above object is further accomplished by a unique position detection method of the present invention that includes the steps of:

acquiring amounts of coincidence of identical reference templates for a position of coincidence of the templates and for a nearby position thereof, the identical reference templates being superimposed;

calculating a coincidence discriminating value based upon a coincidence amount of the position of coincidence and a coincidence amount of the nearby position;

acquiring amounts of coincidence between one of the reference templates and an inputted image for a maximum value position at which an amount of the coincidence between such one of the reference templates and the inputted image shows a maximum value and for a nearby position of the maximum value position; and

judging that the maximum value position is a coincidence position between such one of the reference templates and the inputted image, in a case where a degree of drop in an amount of coincidence at the nearby position of the maximum value position with respect to a maximum value of amount of coincidence between such one of the reference templates and the inputted image is greater than the coincidence discriminating value.

### BRIEF DESCRIPTION OF THE DRAWINGS

FIG. 1 is a block diagram that shows the schematic structure of a bonding apparatus according to one embodiment of the present invention;

FIG. 2 is a graph that shows the self-correlation curve;

FIG. 3 is a flow chart that shows the processing used to store the template image and to judge the suitability or unsuitability of the image;

FIG. 4 is a flow chart that shows position detection using pattern matching and the processing used to judge the satisfactory or unsatisfactory nature of the position obtained;

FIG. 5 is an explanatory diagram which shows another method for judging coincidence between the template image and inputted image using a numerical formula based on C language;

FIG. 6 is an explanatory diagram that shows a long pattern oriented at an oblique angle with respect to the X and Y directions; and

FIG. 7 is an explanatory diagram that shows the process used to calculate the amount of coincidence for a loop-form region.

### DETAILED DESCRIPTION OF THE INVENTION

Embodiments of the present invention will be described below with reference to the accompanying drawings.

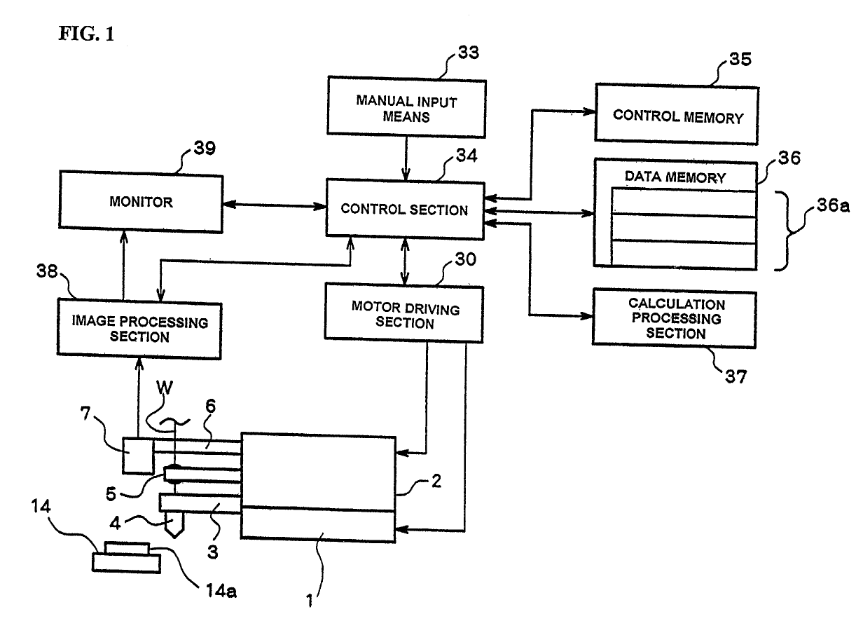

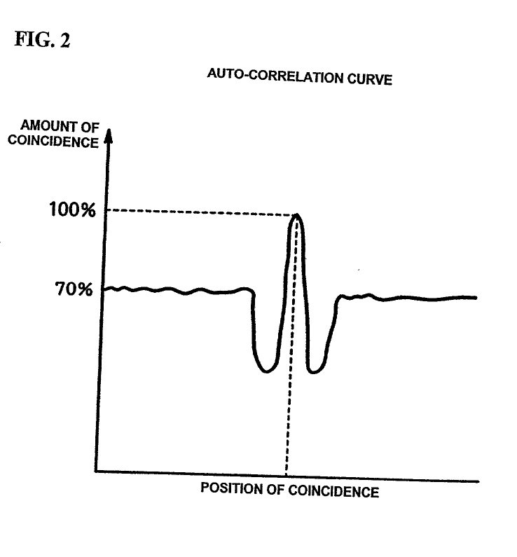

FIG. 1 shows the schematic construction of a wire bonder constructed according to an embodiment of the present invention. In FIG. 1, a bonding arm 3 is disposed on a bonding head 2 that is mounted on an XY table 1, and this bonding arm 3 is driven upward and downward in the vertical direction by a Z-axis motor (not shown). A damper 5 that holds a wire W is disposed above the bonding arm 3, and the lower end of this wire W is passed through a tool 4. The tool 4 in the present embodiment is a capillary.

A camera arm 6 is also fastened to the bonding head 2, and a camera 7 is fastened to the camera arm 6. The camera 7 images a wiring board 14 on which a semiconductor chip, etc., 14a is mounted. The XY table 1 is constructed so that this table can be accurately moved in the X and Y directions (which are the directions of mutually perpendicular coordinate axes in the horizontal direction) by XY table motors (not shown) consisting of two pulse motors, etc. that are installed in close proximity to the XY table. The structure described so far is a universally known structure.

The XY table 1 is driven via a motor driving section 30 and the XY table motors by commands from a control section 34 consisting of a microprocessor, etc. The images acquired by the camera 7 are converted into electrical signals and processed by an image processing section 38, and are inputted into a calculation processing section 37 via the control section 34. Various calculations that will be described later are performed in the calculation processing section 37. System operating programs including programs for such calculations are temporarily held in a control memory 35. A manual input means 33 and a monitor 39 are connected to the control section 34.

At least a pointing device such as a mouse input device (called “mouse”) which a direction indicating function for the X and Y directions and a setting signal input function using an input switch, and a keyboard, etc., which has a character input function, are suitable as the manual input means 33. The monitor 39 consists of a CRT or a liquid crystal display device, etc.; images of the wiring board 14, etc., acquired by the camera 7 are displayed on the display screen (not shown) of this monitor 39 based upon the operating input of the operator and the output of the control section 34.

A data library 36a in which template images registered in the past, set values such as self-correlation values and threshold values, etc. (described later), default values which are the initial states of these values, and set values used in other operations of the present device are stored, is accommodated in a data memory 36.

In the present embodiment, pattern matching (rough detection) is performed using a rough image with a relatively large reduction rate for the image of the semiconductor chip 14a, which is inputted in an enlarged state relative to the original dimensions of the image. Then, pattern matching (fine detection) is performed using a fine image with a relatively small reduction rate. The processing of this fine detection will be described below. In the present embodiment, storage of the template image and judgment of the appropriateness of the stored template image are first performed as training processing; next, position detection using pattern matching and judgment of the suitability of the position obtained by this detection are performed as processing in the run time.

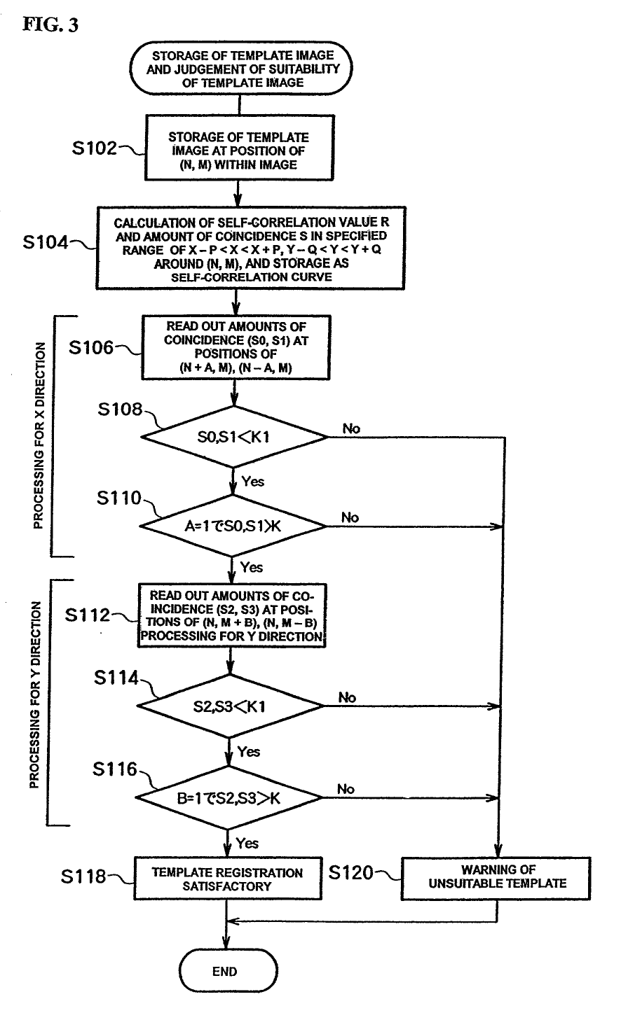

FIG. 3 shows the processing of the storage of the template image and judgment of the appropriateness of this image. First, in a state in which the operator has matched the pointer with the position coordinates (N, M), which represent an arbitrary point on the image of the semiconductor chip 14a that has been acquired beforehand by the camera 7 and displayed on the monitor 39, an image of the area displayed on the monitor 39 is stored in the data memory 36 as a template image by using the manual input means 33 to input a setting signal (e.g., by indicating the direction using a mouse, and pressing the setting switch of the mouse) (S102).

Next, using the stored template image, self-correlation values R₀ are calculated for respective pixels within specified ranges in the X and Y directions centered on the coordinates (N, M), i.e., within the ranges of X−P<X<X+P, Y−Q<Y<Y+Q. Furthermore, the amount of coincidence S is calculated based upon the range in which self-correlation values can be sought (−1<R₀21 1). In this way, a self-correlation curve which is the curve formed by the values of the amount of coincidence S, is determined; and this curve is stored in the data memory 36 (S104).

Here, the self-correlation value R₀ refers to a normalized correlation value of identical patterns, and is defined by the following equation.

Numerical Expression 1

$${R}_{0} = \frac{\{ N Σ I M - \{ Σ I Σ M \} \}}{\sqrt{\{ N Σ {I}^{2} - {\{ Σ I \}}^{2} \} \{ N Σ {M}^{2} - {\{ Σ M \}}^{2} \}}}$$

Range of R₀:−<R₀ 21 1

S=Min(Max(R₀, 0), 1)×100

Here, R₀ is the self-correlation value, S is the amount of coincidence, N is the number of pixels within the template image, I is the brightness value at respective positions within the template image, and M is the brightness value of the template image.

Next, in steps S106 through S 120, the appropriateness of the template image is ascertained using the amounts of coincidence S at respective points on the previously calculated self-correlation curve. Furthermore, steps S106 through S110 consists of processing for the X direction, while steps S112 through S116 consist of processing for the Y direction.

First, the amounts of coincidence S0 and S1 for the coordinates (N+A,M) and the coordinates (N−A, M) are read out from the data memory 36 (S106).

Next, a judgment is made as to whether or not the amounts of coincidence S0 and S1 are less than a specified reference value K1 (S108). This judgment is made in order to check whether or not the amount of coincidence S drops in a position near the position of coincidence. The reason for this is that a template image which is such that the amount of coincidence S drops to a certain extent in a position near the position of coincidence is suitable for use in position detection in the present invention. The reference value K1 used here is a value that is set in advance in accordance with the type of the objects of recognition and is the amount of coincidence S in a case where the objects of recognition are caused to slide relative to each other by A pixels (in the X direction) from the position of coincidence. Here, this is used as an upper-limit value. Furthermore, in regard to the value of A, a value of (e.g.) 4 is used in the case of a pad on a semiconductor chip, and a value of (e.g.) 20 is used in the case of a lead. The reason that the value used in the case of a pad is smaller than the value used in the case of a lead is that the pattern is ordinarily formed by printing in the case of a pad, so that there is less distortion.

In the case of an affirmative in this step S108, i.e., in a case where the amounts of coincidence S0 and S1 are smaller than the reference value K1,the amounts of coincidence S0 and S1 at the point where A=1 are next read out form the data memory 36 in step S110, and are compared with the reference value K (S110). This judgment is performed in order to check whether or not the amount of coincidence S has shown an extreme drop in a position proximate to the position of coincidence (here, a pixel adjacent to the position of coincidence).

The reason for this is that a template image which is such that the amount of coincidence S shows an extreme drop in a position proximate to the position of coincidence is a pattern that is extremely small with respect to the direction of the coordinate axis (e.g., a longitudinal stripe that is long and slender in the Y direction for pattern matching in the X direction), and is unsuitable for pattern matching. The reference value K used here is a value that is set in advance in accordance with the type of the objects of recognition, and is a lower-limit value for the pattern thickness which is such that the probability of erroneous recognition does not exceed a permissible value in a case where the objects of recognition are caused to slide from the position of coincidence by one pixel in the X direction. Here, this value is used as a lower-limit value.

In the case of a yes in steps S108 and S110, similar processing is also performed for the Y direction.

First, the amounts of coincidence S2 and S3 for the coordinates (N, M+B) and the coordinates (N, M−B) are read out from the data memory 36 (S112).

Next, a judgment is made as to whether or not the amounts of coincidence S2 and S3 are less than the reference value K1 (S114). The reference value K1 used here is a value that is set in advance according to the type of the objects of recognition, and is the amount of coincidence S in a case where the objects of recognition are caused to slide relative to each other by B pixels (in the Y direction) from the position of coincidence. Here, this value is used as an upper-limit value. Furthermore, in regard to the value of B, a value of, for instance, 4 is used in the case of pad on the semiconductor chip 14a, and a value of (e.g.) 20 is used in the case of a lead.

In the case of a yes in this step S114, i.e., in a case where the amounts of coincidence S2 and S3 are smaller than the reference value K1, the amounts of coincidence S2 and S3 at the point where B=1 are next read out of the data memory 36 in step S116, and are compared with the reference value K (S116). The reference value K used here is a value that is set in advance in accordance with the type of the objects of reference, and is a lower-limit value for the pattern thickness which is such that the probability of erroneous recognition does not exceed a permissible value in a case where the objects of recognition are caused to slide from the position of coincidence by 1 pixel in the Y direction. Here, this value is used as a lower-limit value.

In the case of a yes in all of the steps S108, S110, S114 and S116, it is considered that the template image is suitable for pattern matching, and this template image is registered in the data memory 36. Furthermore, a message indicating that registration has been completed is outputted by, for instance, a character display on the monitor 39 (S118).

On the other hand, in the case of a no in any of the steps S108, S110, S114 or S116, it is considered that the template image in question is unsuitable for pattern matching, and a warning message is outputted by, for instance, a character display on the monitor 39 (S120). With this, this routine is ended. When a warning message is displayed, the operator selects a different point within the image, and re-executes this routine for this different point.

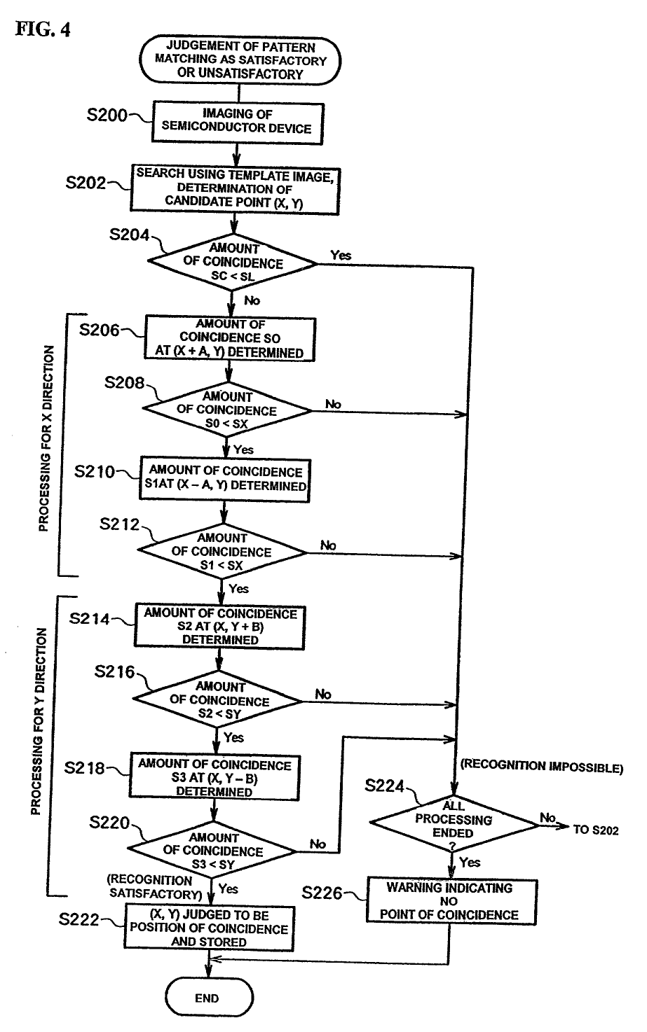

FIG. 4 shows the processing of position detection using pattern matching, and the processing of the judgment of the suitability of the position obtained. First, the semiconductor chip 14a is imaged by the camera 7 (S200), and an inputted image which constitutes the object of recognition is inputted.

Next, using the previously registered template image, the inputted image is searched, and a candidate point (X, Y) for the position of coincidence is determined (S202). The search of this inputted image is accomplished by the same method as in conventional pattern matching, e.g., by calculating a correlation value R1 of the template image and inputted image for each pixel within the area of the inputted image using a numerical formula for a normalized correlation similar to the Numerical Expression 1 (however, the self-correlation value R₀ in Numerical Expression 1 is replaced by the correlation value R1), and calculating the amount of coincidence S based upon the range of values that can be adopted by the correlation value R1 (−1 ≦R1≦1). The point where the calculated amount of coincidence S shows a maximum value is the candidate point.

Next, a judgment is made as to whether or not the amount of coincidence SC for this candidate point (X, Y) is smaller than a specified reference value SL (S204). Pints where the amount of coincidence SC is excessively low are extremely unlikely to be the position of coincidence even if such points are points where a maximum value is shown; accordingly, the judgment excludes such points from candidacy. Furthermore, the reference value SL used here is a value similar to the threshold value used in conventional pattern matching, e.g., a value of 50%.

In steps S206 through S222, processing is performed in which the amounts of coincidence S0, S1, S2 and S3 of the template image and inputted image in positions near the candidate point (which is the point where the amount of coincidence S shows a maximum value) are compared with a threshold value Sx (for the X direction) or Sy (for the Y direction) used as a coincidence discriminating value, and the candidate point is judged to be the position of coincidence if the amount of coincidence is less than the threshold value (i.e., if the drop in the amount of coincidence S in the nearby position in question is large relative to the maximum value of the amount of coincidence S). The threshold values Sx and Sy are values obtained by multiplying the amounts of coincidence S0, S1, S2 and S3 determined previously for the template image in the vicinity of the position of coincidence by the ratio of the amount of coincidence SC at the position of coincidence for the inputted image to the amount of coincidence S (100%) at the position of coincidence for the template image (if SC=60%, this ratio is 0.6), and then further multiplying this value by a specified tolerance. Furthermore, steps S206 through S212 consist of processing for the X direction, and steps S214 through S220 consist of processing for the Y direction.

First, the amount of coincidence SO between the template image and the inputted image is calculated for the coordinates (X+A, Y) (S206). Next, this amount of coincidence S0 is compared with the threshold value Sx (208), and an affirmative is obtained if S0 is less than the threshold value Sx.

Next, the amount of coincidence S1 between the template image and the inputted image is calculated for the coordinates (X−A, Y) (S210). Then, this amount of coincidence S1 is compared with the threshold value Sx (S212), and an affirmative is obtained if S1 is less than the threshold value Sx.

Next, the amount of coincidence S2 between the template image and the inputted image is calculated for the coordinates (X, Y+B) (S214). Then, this amount of coincidence S2 is compared with the threshold value Sy (S216), and an affirmative is obtained if S2 is less than the threshold value Sy.

Next, the amount of coincidence S3 between the template image and the inputted image is calculated for the coordinates (X, Y−B) (S218). Then, this amount of coincidence S3 is compared with the threshold value Sy (S220), and an affirmative is obtained if S3 is less than the threshold value Sy.

Then, in the case of a yes in all of the steps S208, S212, S216 and S220, the candidate point (X, Y) is judged to be the position of coincidence, and is stored in the data memory 36 as processing in the case of satisfactory recognition (S222).

Furthermore, in the case of a no in any of the steps S208, S212, S216 and S220, the processing of steps S202 through S220 is repeated for other candidate points within the area of the inputted image as processing in a case where recognition is impossible (S224). In a case where processing has been completed for all of the candidate points, and results indicating satisfactory recognition have not been obtained, an affirmative appears in step S224, and this is considered to be a case in which there is no point of coincidence. Accordingly, a warning message is outputted by, for instance, means of a character display on the monitor 39, etc. (S226). With above, this routine is ended. Furthermore, in cases where a warning message is displayed, the operator inputs an inputted image for another area of the semiconductor chip 14a by imaging this other area, and causes this routine to be re-executed for this other area.

Thus, in the present embodiment, the amount of coincidence S for template images that are identical reference templates is calculated at the position of coincidence of the template images and at a nearby position, and threshold values Sx and Sy used for the discrimination of coincidence are calculated based upon the amount of coincidence S at the position of coincidence and the amount of coincidence at this nearby position. Separately, the amount of coincidence S between this template image and an inputted image is calculated at the position where the amount of coincidence between the template image and the inputted image shows a maximum value, and at a position near this position where a maximum value is shown. Then, in cases where the drop in the amount of coincidence S between the template image and the inputted image at the nearby position is large, i.e., in cases where the amount of coincidence S drops abruptly at a position near the position of coincidence, the position where a maximum value is shown is judged to be the position of coincidence between the template image and the inputted image.

In the above embodiment, therefore, erroneous detection due to the fact that the point where the amount of coincidence (or correlation value) shows a maximum value is considered to be the position of coincidence does not occur as it does in conventional methods. Instead, it can be judged with a high degree of precision whether or not the template image and inputted image in a certain relative position are in the position of coincidence.

Furthermore, in the above-described embodiments, the correlation value R and the amount of coincidence S derived from the range of values that can be adopted by the correlation value R are used as indicators for evaluating the amount of coincidence between the template images or the amount of coincidence between the template image and the inputted image. However, such a structure is merely an example; and it is possible to use the correlation value R “as is”0 as the amount of coincidence. Furthermore, in regard to the amount of coincidence used in the present invention, various other types of universally known methods for evaluation degrees of coincidence may be employed; for example, a method using the residual difference may be used. Furthermore, in cases where the amount of coincidence between binary images is evaluated, a count value obtained by a method in which pixels whose values coincide are counted as 1, and pixels whose values do not coincide are counted as 0, may be used as the amount of coincidence.

Also, in the above-described embodiments, a self-correlation curve is determined beforehand (S104), and the amounts of coincidence S at respective points on this self-correlation curve are read out (S106, S112). However, instead of such a structure, it is also possible that only the amounts of coincidence S0, S1, S2 and S3 for the coordinates (N+A, M), (N−A, M), (N, M+B) and (N, M−B) are calculated in a pinpoint manner, instead of determining a self-correlation curve for all of the pixels in the area surround the coordinates (N, M).

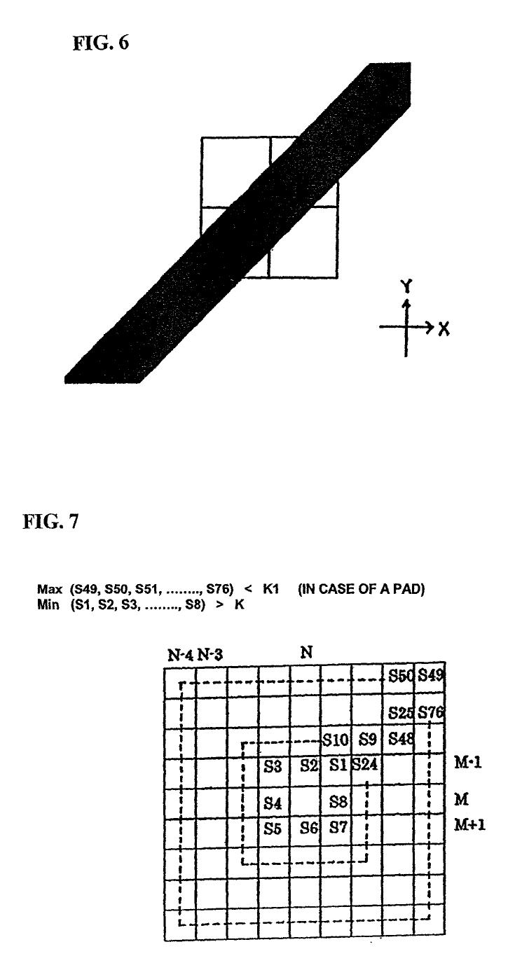

However, when the amount of coincidence S is thus calculated in a pinpoint manner for the coordinates of four points, there is a possibility of erroneous judgment as satisfactory, even if the template image is unsuitable, in the case of a long pattern oriented at an oblique angle to the X and Y directions as shown in FIG. 6. Such a long pattern oriented at an oblique angle is not commonly used in the semiconductor field. However, in order to prevent such erroneous judgments, such a structure can be used that the amount of coincidence is calculated for each pixel in a loop-form area surrounding the coordinates (N, M) (in FIG. 7, this is the area of the pixels connected to each other by the dotted line), the maximum value of these amounts of coincidence (e.g., in the case of a pad, the maximum value among S49 through S76 calculated for the pixels of the outermost circumference in FIG. 7; in the case of a lead, the maximum values of the amounts of coincidence S calculated for each pixel in a loop-form area located even further to the outside (not shown)) is compared with the reference value K1 in step S108, and the minimum value of these amounts of coincidence (the minimum value among S1 through S8 calculated for the eight pixels surrounding the central pixel in FIG. 7) is compared with the reference value K in step S10. Furthermore, besides being rectangular, the shape of the loop formed by the pixels may also be a shape that is close to round.

In addition, in the above-described embodiments, the amount of coincidence S between the template image and the inputted image is calculated for each pixel within the area of the inputted image, the point where the calculated amount of coincidence S showed a maximum value is taken as the candidate point, and a judgment of coincidence is made for such a candidate point according to the order of detection (step S202, etc.). However, instead of such a structure, it is also possible to use a structure in which a judgment of coincidence is made according to the order of the magnitude of the detected amount of coincidence S.

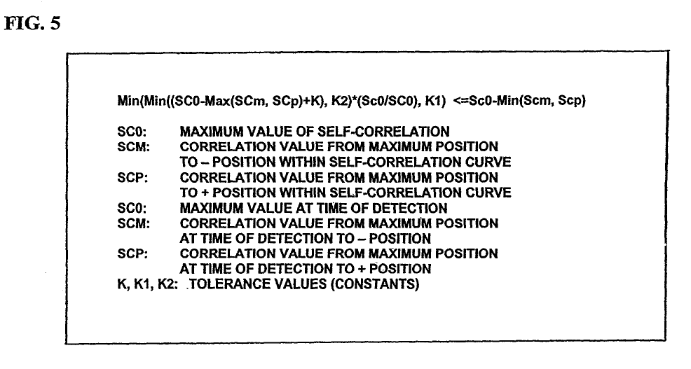

Furthermore, in the above-described embodiments, the condition of the amounts of coincidence S0, S1, S2 and S3 at positions near the position of a maximum amount of coincidence S between the template image and the inputted image being lower than the threshold values Sx and Sy is used as a condition for judging coincidence. However, instead of such a structure, it is also possible to use a structure in which the condition of whether or not the difference (or amount of variation) between the amount of coincidence S at the position where the amount of coincidence S between the template image and the inputted image show a maximum value and the amount of coincidence S at a position near this position where a maximum value is shown exceeds the value obtained by multiplying the difference (or amount of variation) between the amount of coincidence S at the position of coincidence between the two template images and the amount of coincidence S at the nearby position by the ratio of the maximum value of the amount of coincidence S between the template image and the inputted image to the maximum value of the amount of coincidence S between the two template images is used as a condition for judging coincidence (FIG. 5). In this case, if the former value exceeds the latter value, this is judged to indicate coincidence.

Furthermore, in the above-described embodiments, the present invention is described with reference to a wire bonding apparatus. However, the present invention can be widely used for position detection in other types of semiconductor manufacturing apparatuses and other apparatuses that use pattern matching. Such are also in the scope of the present invention.

1. A position detection device comprising:
a means which acquires amounts of coincidence of identical reference templates for a position of coincidence of said templates and for a nearby position thereof, said identical reference templates being superimposed;
a means which calculates a coincidence discriminating value based upon a coincidence amount of said position of coincidence and a coincidence amount of said nearby position;
a means which acquires amounts of coincidence between one of said reference templates and an inputted image for a maximum value position at which an amount of said coincidence between said reference templates and said inputted image shows a maximum value and for a nearby position of said maximum value position; and
a means which judges that said maximum value position is a coincidence position between said one of reference templates and said inputted image, in a case where a degree of drop in an amount of coincidence at said nearby position of said maximum value position with respect to a maximum value of amount of coincidence between said one of reference templates and said inputted image is greater than said coincidence discriminating value.

2. A position detection method comprising the steps of:
acquiring amounts of coincidence of identical reference templates for a position of coincidence of said templates and for a nearby position thereof, said identical reference templates being superimposed;
calculating a coincidence discriminating value based upon a coincidence amount of said position of coincidence and a coincidence amount of said nearby position;
acquiring amounts of coincidence between one of said reference templates and an inputted image for a maximum value position at which an amount of said coincidence between said reference templates and said inputted image shows a maximum value and for a nearby position of said maximum value position; and
judging that said maximum value position is a coincidence position between said one of reference templates and said inputted image, in a case where a degree of drop in an amount of coincidence at said nearby position of said maximum value position with respect to a maximum value of amount of coincidence between said one of reference templates and said inputted image is greater than said coincidence discriminating value.
